(19) United States
(12) Patent Application Publication
(10) Pub. No.: US 2014/0195607 A1
(43) Pub. Date: Jul. 10, 2014

(54) COMMUNICATION DEVICES, SERVERS, METHODS FOR CONTROLLING A COMMUNICATION DEVICE, AND METHODS FOR CONTROLLING A SERVER

(71) Applicant: Frank Kowalewski, Goettingen (DE)

(72) Inventor: Frank Kowalewski, Goettingen (DE)

(73) Assignee: Intel Mobile Communications GMBH, Neubiberg (DE)

(21) Appl. No.: 13/976,531

(22) PCT Filed: Jul. 30, 2012
(86) PCT No.: PCT/EP2012/064879

§ 371 Date: Jun. 27, 2013

(51) Int. Cl. H04L 29/08; H04L 29/06

(52) U.S. Cl. CPC H04L 67/104; H04L 67/06; H04L 65/1006
USPC 709/204

(57) ABSTRACT

A communication device may be provided. The communication device may include: a requester to request information indicating communication devices that provide pre-determined data; a receiver to receive the information indicating communication devices that provide the pre-determined data; a determiner to determine a download target based on the information indicating communication devices that provide the pre-determined data; and a transmitter to transmit information indicating the determined download target for a peer-to-peer communication of the pre-determined data from the download target.

### TECHNICAL FIELD

Aspects of this disclosure relate generally to communication devices, servers, methods for controlling a communication device, and methods for controlling a server.

### BACKGROUND

In peer-to-peer communication, a communication device may download data from one of a plurality of other communication devices. Usually, a network provider does not get information about the peer-to-peer communication from the communication devices. However, a network operator may be interested in receiving such information.

### SUMMARY

A communication device may be provided. The communication device may include: a requester to request information indicating communication devices that provide pre-determined data; a receiver to receive the information indicating communication devices that provide the pre-determined data; a determiner to determine a download target based on the received information indicating communication devices that provide the pre-determined data and a transmitter to transmit information indicating the determined download target for a peer-to-peer communication of the pre-determined data from the download target.

A server may be provided. The server may include: a request receiver to receive from a communication device a request for information indicating communication devices that provide pre-determined data; a determiner to determine communication devices that provide the pre-determined data a transmitter to transmit to the communication device the requested information indicating communication devices that provide the pre-determined data; and a receiver to receive from the communication device information indicating a download target for a peer-to-peer communication of the pre-determined data from the download target to the communication device.

A method for controlling a communication device may be provided. The method may include: requesting information indicating communication devices that provide pre-determined data; receiving the information indicating communication devices that provide the pre-determined data; determining a download target based on the received information indicating communication devices that provide the pre-determined data; and transmitting information indicating the determined download target for a peer-to-peer communication of the pre-determined data from the download target.

A method for controlling a server may be provided. The method may include: receiving from a communication device a request for information indicating communication devices which provide pre-determined data; determining communication devices that provide the pre-determined data; transmitting to the communication device the requested information, indicating communication devices that provide the pre-determined data; and receiving from the communication device information indicating a download target for a peer-to-peer communication of the pre-determined data from the download target to the communication device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various aspects of this disclosure. In the following description, various aspects of this disclosure are described with reference to the following drawings, in which:

FIG. 1 shows a communication system for peer-to-peer communication using the Session Initiation Protocol;

FIG. 2 shows a flow diagram for setting up a peer-to-peer communication in the communication system of FIG. 1;

FIG. 3 shows a flow diagram for changing a peer-to-peer communication in the communication system of FIG. 1;

FIG. 4 shows a communication system for peer-to-peer communication using the Message Session Relay Protocol;

FIG. 5 shows a flow diagram for setting up a peer-to-peer communication in the communication system of FIG. 4;

FIG. 6 shows a flow diagram for changing a peer-to-peer communication in the communication system of FIG. 4;

FIG. 7 shows a communication device for peer-to-peer communication;

FIG. 8 shows a server for peer-to-peer communication;

FIG. 9 shows a server with a download initiating circuit for peer-to-peer communication;

FIG. 10 shows a flow diagram illustrating a method for controlling a communication device of FIG. 7;

FIG. 11 shows a flow diagram illustrating a method for controlling a server of FIG. 8;

FIG. 12 shows a communication device for peer-to-peer communication;

FIG. 13 shows a server for peer-to-peer communication;

FIG. 14 shows a flow diagram illustrating a method for controlling a communication device of FIG. 12; and

FIG. 15 shows a flow diagram illustrating a method for controlling a server of FIG. 13.

### DESCRIPTION

The following detailed description refers to the accompanying drawings that show, by way of illustration, specific details and aspects of the disclosure in which the invention may be practiced. These aspects of the disclosure are described in sufficient detail to enable those skilled in the art to practice the invention. Other aspects of the disclosure may be utilized and structural, logical, and electrical changes may be made without departing front the scope of the invention. The various aspects of the disclosure are not necessarily mutually exclusive, as some aspects of the disclosure may be combined with one or more other aspects of the disclosure to form new aspects of the disclosure.

The terms “coupling” or “connection” are intended to include a direct “coupling” or direct “connection” as well as an indirect “coupling” or indirect “connection”, respectively.

The word “exemplary” is used herein to mean “serving as an example, instance, or illustration”. Any aspect of this disclosure or design described herein as “exemplary” is not necessarily to be construed as preferred or advantageous over other aspects of this disclosure or designs.

The term “protocol” is intended to include any piece of software, that is provided to implement part of any layer of the communication definition.

A communication device (which may also be referred to as end device or communication end device) as referred to herein may be a device configured for wired communication, for example a desktop computer or laptop, or for wireless communication, for example a radio communication device. Furthermore, a radio communication device may be an end-user mobile device (MD). A radio communication device may be any kind of mobile radio communication device, mobile telephone, personal digital assistant, mobile computer, or any other mobile device configured for communication with a mobile communication base station (BS) or an access point (AP) and may be also referred to as a User Equipment (UE), a mobile station (MS) or an advanced mobile station (advanced MS, AMS), for example in accordance with IEEE 802.16m.

The communication device may include a memory which may for example be used in the processing carried out by the communication device. The server may include a memory which may for example be used in the processing carried out by the server. A memory may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, for example, a floating gate memory, a charge trapping memory, an MRAM (Magnetoresistive Random Access Memory) or a PCRAM (Phase Change Random Access Memory).

As used herein, a “circuit” may be understood as any kind of a logic implementing entity, which may be special purpose circuitry or a processor executing software stored in a memory, firmware, or any combination thereof. Furthermore, a “circuit” may be a hard-wired logic circuit or a programmable logic circuit such as a programmable processor, for example a microprocessor (for example a Complex Instruction Set Computer (CISC) processor or a Reduced Instruction Set Computer (RISC) processor). A “circuit” may also be a processor executing software, for example any kind of computer program, for example a computer program using a virtual machine code such as for example Java. Any other kind of implementation of the respective functions which will be described in more detail below may also be understood as a “circuit”. It may also be understood that any two (or more) of the described circuits may be combined into one circuit.

Description is provided for devices, and description is provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein.

Devices and methods may be provided for peer-to-peer content distribution via the Session Initiation Protocol. Peer-to-peer content distribution services may be provided, which may be based on the IP (Internet Protocol) Multimedia Subsystem (IMS), which may enable charging specifically for peer-to-peer services, which may enable charging depending on content, which may enable charging depending on peer upload, which may enable content protection, and which may ensure QoS (Quality of Service).

Peer-to-peer (P2P) content distribution may be based on distributed transmission of data that partitions workloads among peers. Peers may be equally privileged, equipotent participants. They may be said to form a peer-to-peer network of nodes. Peers may be user peers (for example communication end devices) or network peers (for example network entities).

Peers may make a portion of their resources, such as data storage and network bandwidth, directly available to other network participants. Peers may be both suppliers and consumers of resources, in contrast to the traditional client-server model where only servers supply (send), and clients consume (receive).

Peer-to-peer systems may implement an abstract overlay network, built at application layer, on top of the native or physical network topology. Such overlays may be used for indexing and peer discovery and may make the P2P system independent from the physical network topology. Content may be exchanged directly over the underlying Internet Protocol (IP) network.

In centralized peer-to-peer systems, a central server may be used for indexing functions and to bootstrap the entire system.

Peers may communicate to the central server via special protocols to control content distribution. For example the BitTorrent protocol may be used.

For downloading content via BitTorrent, the participant may surf a torrent file of MIME (Multipurpose Internet Mail Extensions) type “application/x-bittorrent” which may be opened by the torrent application.

The torrent file may include meta data about the content to be downloaded including the URL of the central tracker server. The peer torrent application may request download information from the tracker by providing a content identifier from the torrent file.

The tracker may respond with a list of peers from which the content can be downloaded.

The peer may then request bitmaps from the other peers including information about which content parts are available at the other peers. In other words: a bitmap of a communication device may indicate which parts of pre-determined data are available in the communication device (in other words: which parts of pre-determined data may be provided by the communication device).

The IP Multimedia Subsystem (IMS) may be an application layer based communication system for providing multimedia services. The IMS may be based on the Session Initiation Protocol (SIP). IMS services may be provided by application servers (ASs).

Drawbacks of commonly used systems may be that P2P may not be provided as its own IMS service, IMS operators may not charge specifically for P2P services, P2P services may not be charged depending on content, P2P services may not be charged depending on peer upload, IMS operators may not ensure content protection, MS operators may not ensure P2P QoS, and SIP messages may not contain large content (SIP messages may be limited to 1300 bytes).

As described herein, devices and methods may be provided which may enable IMS based P2P services by using SIP messages for P2P control. This may provide that P2P may be provided by IMS operators as an IMS service, IMS operators may charge specifically for P2P services, P2P services may be charged depending on content, P2P services may be charged depending on peer upload, IMS operators may ensure content protection, IMS operators may ensure P2P QoS, long peer lists may be provided, long bitmaps may be provided, no polling for peer list changes may be required, and no polling for bitmap changes may be required.

Specific SIP messages may be used to exchange P2P control information.

A peer may request peer lists by sending a SIP SUBSCRIBE request to the P2P application Server (AS). The P2P AS may act as a P2P tracker. It may respond a peer list in SIP NOTIFY requests. For transporting long peer lists, the SIP NOTIFY requests may contain or include peer list deltas.

The SIP SUBSCRIBE request may subscribe to a new P2P event package.

SIP SUBSCRIBE and NOTIFY requests may be sent outside or inside an existing SIP dialog.

A peer may request bitmaps from other peers by sending a SIP SUBSCRIBE request to the other peers. The other peers may respond bitmaps in SIP NOTIFY requests. When another peer's bitmap information changes, the peer may send further SIP NOTIFY requests to the subscribing peer to inform about the changes.

A peer may request content segments from other peers by sending a SIP INVITE request to the other peers. For requesting further segments, the peer may send SIP re-INVITE requests.

SIP SUBSCRIBE requests for requesting bitmaps may be sent inside or outside an INVITE dialog for requesting segments.

The bitmap and segment requests and responses may be routed via the P2P AS so that the P2P AS may collect information relevant for charging and may ensure content protection and QoS for content segment distribution.

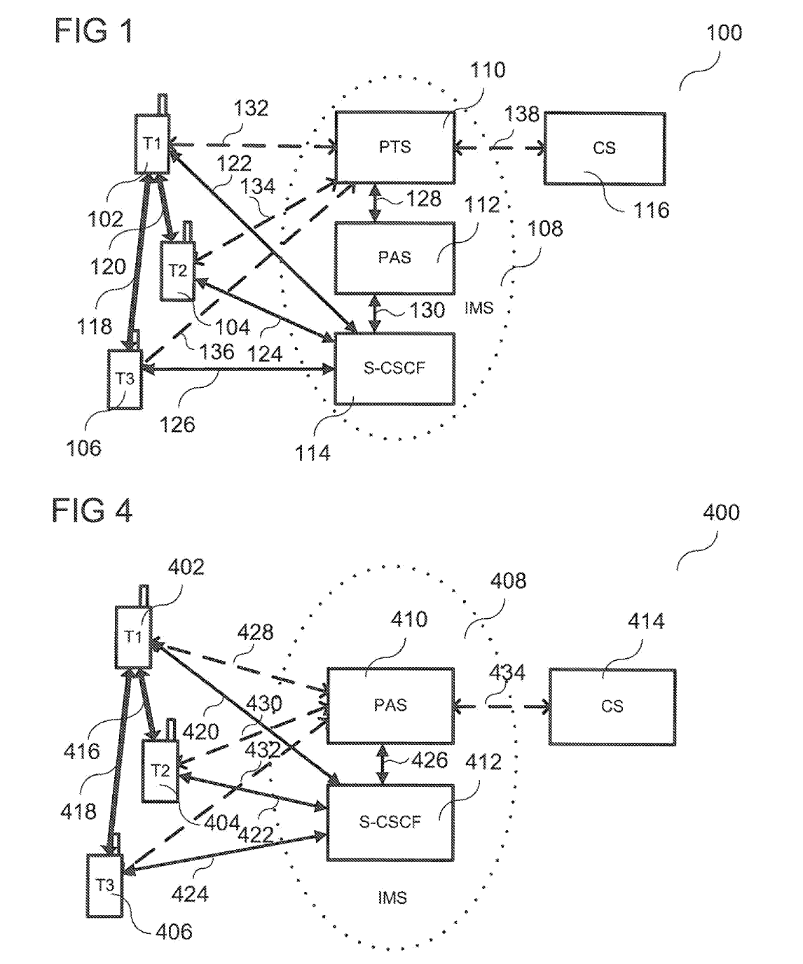

FIG. 1 shows a communication system 100 for peer-to-peer communication using the Session Initiation Protocol. An IP Multimedia Subsystem (IMS) 108 may be provided. A first user U1 and a second user U2 may be registered in the IMS 108 with their end devices (in other words: communication devices; in other words: terminals), for example a first communication device T1 102 and a second communication device T2 104. The IMS 108 may provide P2P services through a P2P application server (AS) PAS 112. In addition T1 and T2 may be able to connect to each other wirelessly via Bluetooth. In the IMS communication system architecture of FIG. 1, further a third communication device (in other words: end device) T3 106 of a third user may be provided. Furthermore, a P2P tracker server (PTS) 110, a serving call session control function (S-CSCF) 114, and a content ever (CS) 116 may be provided. P2P signaling connections are indicated by continuous thin arrows 122, 124, 126, 128, and 130. Data connections are indicated by continuous thick arrows 118 and 120. P2P status notification connections are indicated by dashed arrows 132, 134, 136, and 138.

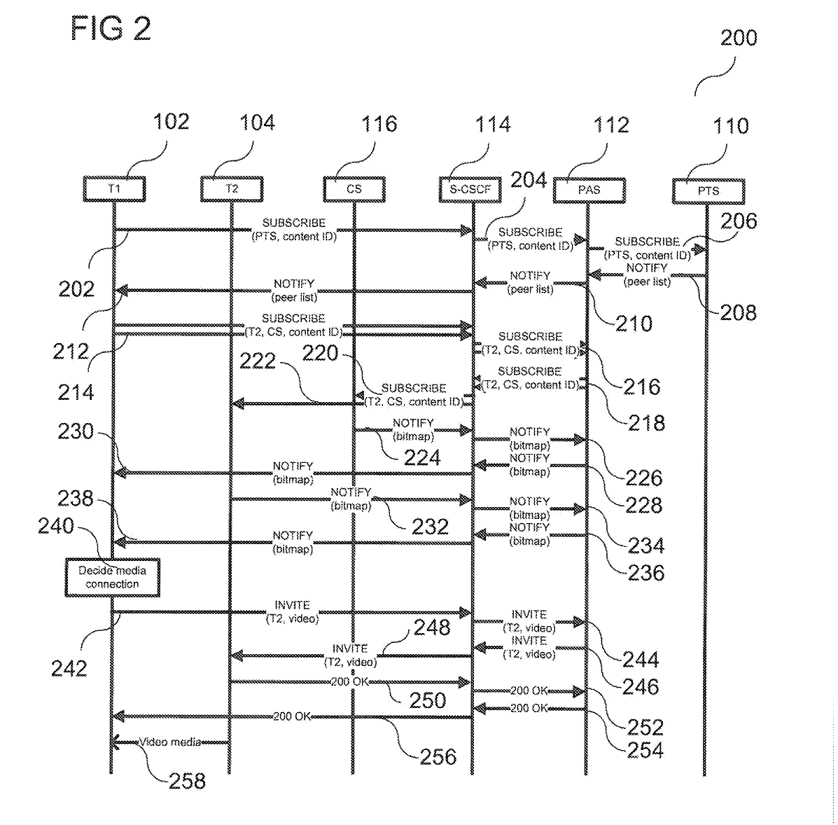

FIG. 2 shows a flow diagram 200 for setting up a peer-to-peer communication in the communication system of FIG. 1. The flow diagram 200 shows the signaling flow for P2P initiation and first segment transmission. For clarity, SIP 200 OK responses to SIP SUBSCRIBE and NOTIFY requests and SIP ACK responses to SIP 200 OK responses may not be shown in the flow diagram 200.

User U1 may want to watch a video of a recent football game. With his end device T1 102 he may visit a video web site provided by his IMS operator. He may find the wanted video and may select a corresponding link. The link may point to a P2P file specifying meta data for the video file to be downloaded. T1's browser may provide the file to the P2P application on T1 102 associated with the P2P file's MIME type.

The P2P application may extract the content identifier (ID) and the tracker URI included in the P2P file.

In 202, the P2P application may send a SIP SUBSCRIBE request to the tracker URI 110. The SIP SUBSCRIBE request may include an Event header field containing the token “p2p_peerlist” and the content ID as an Event header parameter. The content of the SIP SUBSCRIBE request for requesting a peer list may be as follows:

SUBSCRIBE sip:tracker@operator.com SIP/2.0
To: <sip:tracker@operator.com>
From: <sip:user1@operator.com>;tag=xfg9
Call-ID: 2012@operator.com
CSeq: 17766 SUBSCRIBE
Max-Forwards: 70
Event: p2p_peerlist;id=1234
Contact: <sip:user1@operator.com>
Expires: 600
Content-Length: 0

The tracker URI included in the SIP SUBSCRIBE's request URI may belong to U1's operator's domain. Therefore, the IMS may route the SIP SUBSCRIBE request to the operator's Serving Call Session Control Function (S-CSCF) 114. The S-CSCF may check the SIP SUBSCRIBE's Event header field and may determine that the SIP SUBSCRIBE request is for P2P service. Therefore, it may forward the request to the operator's P2P AS PAS 112 in 204.

In 206, the P2P AS PAS 112 may request the relevant peer list from the P2P tracker server PTS 110 specified by the SIP SUBSCRIBE's request URI. Then, in 208, PAS 112 may receive from the PTS 110 a SIP NOTIFY request and, in 210 and 212 may send the SIP NOTIFY request back to T1 102 including the peer list in its XML body. The XML body may also include the (peer list) version number 1. The SIP NOTIFY request including peer list data may be as follows:

NOTIFY sip:user1@operator.com SIP/2.0
From: <sip:tracker@operator.com>;tag=ffd2
To: <sip:user1@operator.com>;tag=xfg9
Call-ID: 2012@operator.com
Event: P2P_peerlist
Subscription-State: active;expires=599
Max-Forwards: 70
CSeq: 8775 NOTIFY
Contact: <sip:tracker@operator.com>
Content-Type: application/xml
Content-Length: 57
...
<xml peer list contents including version no. 1>.

The peer list may include entries of URIs pointing to peers that currently have segments for the wanted video available. In this example, the peer list may include two entries, one for U2's device T2 104 and one for a content server CS 106 in the network (a network peer).

After having received the peer list, end device T1 102 may send SIP SUBSCRIBE requests to T2 104 and CS 116. The SIP SUBSCRIBE requests may include an Event header field containing the token “p2p_bitmap” and the content ID as an Event header parameter. The content of the SIP SUBSCRIBE request for requesting a bitmap may be as follows:

SUBSCRIBE sip:user2@operator.com SIP/2.0
To: <sip:user2@operator.com>
From: <sip:user1@operator.com>;tag=xfg9
Call-ID: 2013@operator.com
CSeq: 35647 SUBSCRIBE
Max-Forwards: 70
Event: p2p_bitmap;id=1234
Contact: <sip:user1@operator.com>
Expires: 600
Content-Length: 0

The SIP SUBSCRIBE requests (214, 216, 218, 220, and 222) may be routed via U1's operator's S-CSCF 114. The S-CSCF 114 may route the SIP SUBSCRIBE requests via the P2P AS PAS 112 to allow it to collect charging related information. The P2P AS 112 finally may route the requests to T2 104 and CS 116.

T2 104 and CS 116 may respond by sending SIP NOTIFY requests back to U1's end device T1 102 in 224, 226, 228, 230 and in 232, 234, 236 238. The SIP NOTIFY requests may include information on which video segments currently are available at T2 104 and CS 116. In this example, T2 104 and CS 116 may indicate that the video's first segment is available from both T2 104 and CS 116. T2's SIP NOTIFY request (in other words: the SIP NOTIFY request from T2 104) including bitmap data may be as follows:

NOTIFY sip:user1@operator.com SIP/2.0
From: <sip:user2@operator.com>;tag=ffd2
To: <sip:user1@operator.com>;tag=xfg9
Call-ID: 2013@operator.com
Event: P2P_bitmap
Subscription-State: active;expires=599
Max-Forwards: 70
CSeq: 34568 NOTIFY
Contact: <sip:user2@operator.com>
Content-Type: application/xml
Content-Length: 85
...
<xml bitmap contents>

After having received the bitmaps, T1 102 may check traffic conditions for potential content transmissions from T2 104 and CS 116. T1 102 may have received traffic conditions for CS 116 in the peer list from the P2P AS PAS 112. For traffic conditions for T2 104, T1 102 may check its Bluetooth connection to T2 104 itself. In this example, it may be assumed that traffic conditions to T2 104 are better than to CS 116. Therefore, in 240, T1 102 may decide to request the first video segment from T2 104.

T1 102 may send a SIP INVITE request to T2 104 via the IMS. The IMS may route the request via U1's operator's S-CSCF 114 and P2P AS PAS 112 to T2 104, like indicated, by arrows 242, 244, 246, and 248. The PAS 112 may collect charging relevant information from the SIP INVITE dialog and may ensure proper content protection and QoS. The SIP INVITE request for media negotiation may be as follows:

INVITE sip:user2@operator.com SIP/2.0
To: <sip:user2@operator.com>
From: <sip:user1@operator.com>;tag=xfg9
Call-ID: 3413an89KU
Content-Type: application/sdp
Content-Length: 57
c=IN IP4 224.2.17.12/127
m=video 49170/2 RTP/AVP 31
...

The SIP INVITE request may include an SDP (Session Description. Protocol) offer for media transfer. T2 104 may accept the offer in a SIP 200 OK response to T1 102 in 250, 252, 254, and 256. T1 may acknowledge the SIP 200 OK response by sending back a SIP ACK response to T2 104.

After having received the SIP ACK response, T2 104 may start sending the first video segment using the connection negotiated in the SIP INVITE transaction in 258.

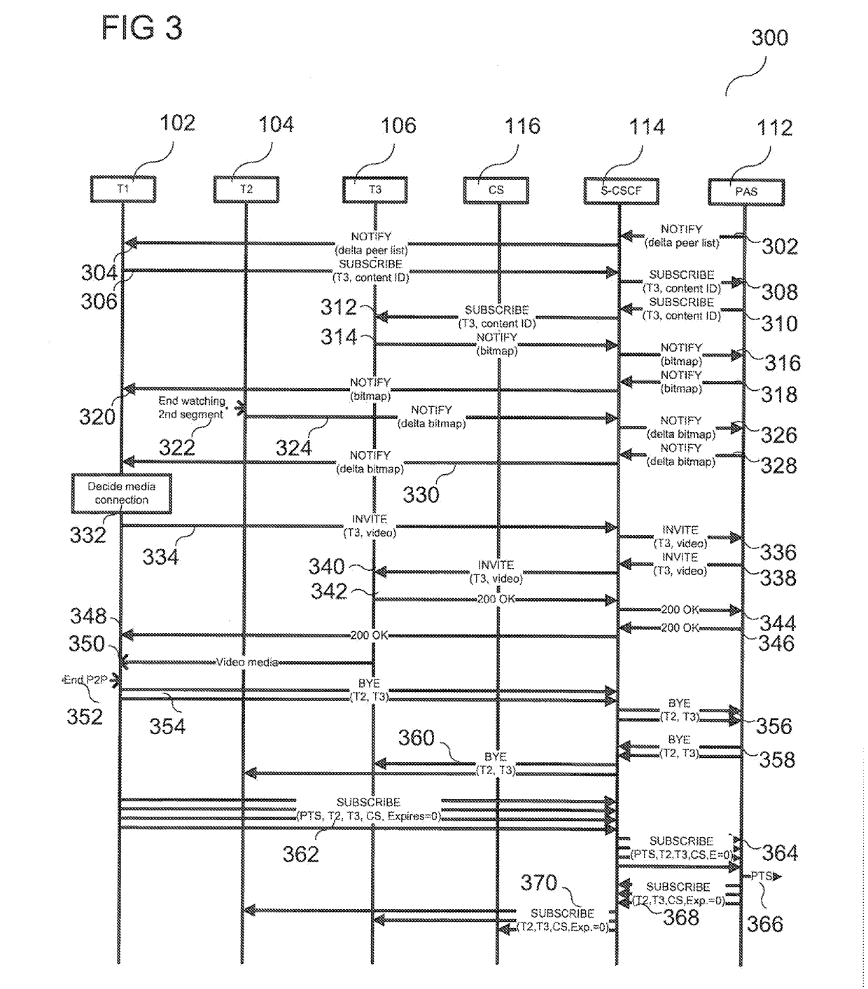

FIG. 3 shows a flow diagram 300 for changing a peer-to-peer communication in the communication system of FIG. 1. In the flow diagram 300, a signaling flow for P2P control and termination is shown. For clarity. SIP 200 OK responses to SIP SUBSCRIBE, NOTIFY and BYE requests and SIP ACK responses to SIP 200 OK responses may not be shown in the flow.

Later another user U3's end device T3 106 also downloading the football video may come into Bluetooth reach of T1 102. Therefore the P2P AS PAS 112 may send another SIP NOTIFY request to T1 in 302 and 304. The SIP NOTIFY request may include a (peer list) version number 2 indicating that delta peer list information is included in the SIP NOTIFY request's XML body. The delta SIP NOTIFY request including delta peer list data may be as follows:

NOTIFY sip:user1@operator.com SIP/2.0
From: <sip:tracker@operator.com>;tag=ffd2
To: <sip:user1@operator.com>;tag=xfg9
Call-ID: 2012@operator.com
Event: P2P_peerlist
Subscription-State: active;expires=463
Max-Forwards: 70
CSeq: 8775 NOTIFY
Contact: <sip:tracker@operator.com>
Content-Type: application/xml
Content-Length: 33
...
<xml delta peer list contents including version no. 2>

T1 102 may then, in 306, 308, 310, and 312, send a SIP SUBSCRIBE request to T3 106 for requesting bitmap information from T3 106, T3 106 may send back a SIP NOTIFY request including its bitmap information in 314, 316, 318, and 320.

During transmission of the first video segment, user U2 may finish watching the second video segment. Therefore, T2 104 may remove the second segment from its memory and may indicate the change to T1 by sending another SIP NOTIFY request to T1 including corresponding delta bitmap information.

At the end of watching the first video segment, in 332, T1 102 may decide to request the second video segment from T3 106 based on the received peer list and bitmap information. T1 102 may send a corresponding SIP INVITE request to T3 106 for negotiating the media connection in 334, 336, 338, and 340. In 342, 344, 346, and 348, T3 106 may transmit a SIP OK response to T1 102. In 350, T1 102 may receive video media from T3 106.

After a while, U1 may decide to stop watching the video in 352. Accordingly, T1 102 may send SIP BYE requests for its SIP INVITE dialogs with T2 104 and T3 106 in 354, 356, 358, and 360. It may also send SIP SUBSCRIBE requests to PTS, T2 104, T3 106 and CS 116 in 362, 364, 366, 368, and 370 with the “Expires” header set to 0 in order to terminate the “P2P_peerlist” and “P2P_bitmap” subscriptions.

The SP BYE request for terminating a media connection to T3 106 may be as follows:

BYE sip: sip:user3@operator.com SIP/2.0
Max-Forwards: 70
From: <sip:user1@operator.com>;tag=gd7e
To: <sip:user3@operator.com>
Call-ID: hsjf7bfjj
CSeq: 231 BYE
Content-Length: 0

The SIP SUBSCRIBE request for terminating a subscription to PTS may be as follows:

SUBSCRIBE sip:tracker@operator.com SIP/2.0
To: <sip:tracker@operator.com>
From: <sip:user1@operator.com>;tag=xfg9
Call-ID: 2012@operator.com
CSeq: 17766 SUBSCRIBE
Max-Forwards: 70
Event: p2p_peerlist;id=1234
Contact: <sip:user1@operator.com>
Expires: 0
Content-Length: 0

As described above, a peer list may be requested by SIP SUBSCRIBE requests. A peer list may be provided by SIP NOTIFY requests. A delta peer list may be provided. Automatic notification about peer list changes may be provided. A bitmap may be requested by SIP SUBSCRIBE requests. A bitmap may be provided by SIP NOTIFY requests. A delta bitmap may be provided. Automatic notification about bitmap changes may be provided. Peer-to-peer control messages may be routed via a peer-to-peer application server. SIP messages may be used for peer-to-peer control.

Instead of the P2P tracker being a separate entity from the P2P AS 112, P2P tracker functionality may be included in the P2P AS 112. In this case, the P2P AS 112 may not need to explicitly request peer lists from P2P trackers.

Instead of including content IDs in SIP SUBSCRIBE requests as Event header parameters, content IDs may be included in the request URI as a parameter or as a prefix or may be included in the SIP SUBSCRIBE's body.

Instead of sending a SIP SUBSCRIBE request for requesting peer lists outside of existing SIP dialogs, the SIP SUBSCRIBE request may be sent inside an existing SIP INVITE dialog. The SIP INVITE dialog may be set up with media ports set to 0, such that no media is being sent. The SIP INVITE request may contain a media feature tag indicating the session's P2P purpose. The SIP INVITE request may also contain the content ID e.g. as a URI parameter or prefix. In this case, the SIP SUBSCRIBE request inside the SIP INVITE dialog may not indicate the content ID.

Instead of requesting peer lists inside an existing SIP INVITE dialog by sending SIP SUBSCRIBE requests, also SIP INFO requests, SIP MESSAGE requests or SIP re-INVITE requests may be sent inside an existing SIP INVITE dialog for requesting peer lists.

For tracking the peers' P2P status, the P2P tracker server may subscribe to peer status events by sending SIP SUBSCRIBE requests to peers.

Instead of sending a SIP SUBSCRIBE request for requesting bitmaps outside of existing SIP dialogs, the SIP SUBSCRIBE request may be sent inside an existing SIP INVITE dialog. The SIP INVITE dialog may be set up with media ports set to 0, such that no media is being sent. The SIP INVITE request may contain the content ID, for example as a URI parameter or prefix. In this case the SIP SUBSCRIBE request may not indicate the content ID. The SIP INVITE dialog may later be used for requesting content segments by sending SIP re-INVITE requests.

Instead of sending a SIP SUBSCRIBE request for requesting bitmaps to a peer, the SIP SUBSCRIBE request may be sent to the P2P AS 112. The P2P AS 112 may send SIP SUBSCRIBE requests to the peers for subscribing to peer P2P status events.

Instead of requesting bitmaps separately from peer lists, bitmaps may be requested together with peer lists from the P2P AS 112 by a single SIP SUBSCRIBE request. In this case, the P2P AS 112 may collect bitmap information from peers and may provide this information in SIP NOTIFY requests.

Bitmap requests and/or segment requests may be sent directly to peers outside IMS signaling.

Furthermore, like will be described below, devices and methods may be provided for peer-to-peer content distribution via the Message Session Relay Protocol. Session based messaging services may be provided within the IMS by initiating message sessions via SIP and transferring messages via the Message Session Relay Protocol (MSRP). Devices and methods may be provided for IMS based P2P services by using MSRP for P2P control and SIP for media control. SIP messages for P2P services may include a new feature tag.

MSRP may be used to exchange P2P control information and SIP may be used to negotiate media transmission.

A peer may request peer lists by setting up an MSRP session with the P2P application Server (AS) and sending an MSRP SEND request to the P2P AS. The P2P AS may act as a P2P tracker. It may respond a peer list in another MSRP SEND request. For transporting long peer lists, multiple MSRP SEND requests containing chunks of the peer list may be sent.

The MSRP session may be set up via SIP INVITE requests including a new media feature tag for indicating the session's P2P purpose.

A peer may request bitmaps from other peers by setting up MSRP sessions with the other peers and sending MSRP SEND requests to the other peers. The other peers may respond their bitmaps in another MSRP SEND request. For transporting long bitmaps, the MSRP SEND requests may contain chunks of the bitmaps.

MSRP sessions for requesting bitmaps may be set up via SIP INVITE requests including a new media feature tag for indicating the session's P2P purpose.

When another peer's bitmap information changes, the other peer may send further MSRP SEND requests to the peer to inform about the changes.

A peer may request content segments from other peers by sending a SIP INVITE request to the other peers. For requesting farther segments, the peer may send SIP re-INVITE requests.

The segment requests and responses may be routed via the P2P AS so that the P2P AS may collect information relevant for charging and may ensure content protection and QoS for content segment distribution.

FIG. 4 shows a communication system 400 for peer-to-peer communication using the Message Session Relay Protocol. In the IMS communication system architecture 400 for P2P service, a first communication device 402 (first end device T1), a second communication device 404 (second end device T2), and a third communication device 406 (third end device T3) may be provided. Furthermore, a P2P application server (PAS) 410 and a serving call session control function (S-CSCF) 412 may be provided in the IP Multimedia Subsystem (IMS) 408. A content server (CS) 414 may be provided. P2P signaling connections are indicated by continuous thin arrows 420, 422, 424, and 426. Data connections are indicated by continuous thick arrows 416 and 418. P2P status notification connections are indicated by dashed arrows 428, 430, 432, and 434.

Users U1 and U2 may be registered in the IMS 408 with their end devices (terminals) T1 402 and T2 404. The IMS 408 may provide P2P services through the P2P application server (AS) PAS 410. In addition, T1 402 and T2 404 may be able to connect to each other wirelessly via Bluetooth, like shown in the architecture of FIG. 4.

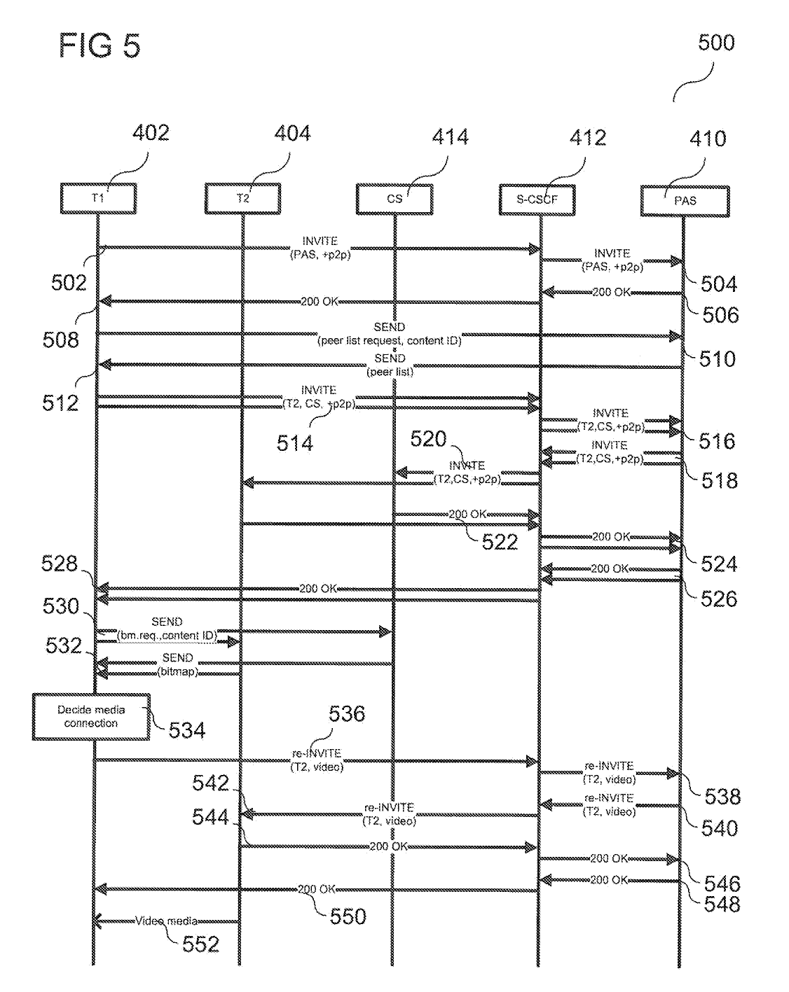

FIG. 5 shows a flow diagram 500 for setting up a peer-to-peer communication in the communication system of FIG. 4. The signaling flow for P2P initiation and first segment transmission is shown. For clarity, MSRP 200 OK responses to MSRP SEND requests and SIP ACK responses to SIP 200 OK responses may not be shown in the flow diagram 500.

User U1 may want to watch a video of a recent football game. With his end device T1 404, he may visit a video web site provided by his IMS operator. He may find the wanted video and may select a corresponding link. The link may point to a P2P file specifying meta data for the video file to be downloaded. T1's browser may provide the file to the P2P application on T1 402 associated with the P2P file's MIME type.

The P2P application may extract the content identifier (ID) and the P2P AS's URI included in the P2P file. The P2P application may send a SIP IN request to the P2P AS 410 in 502 and 504. The SIP INVITE request may include a media feature tag ‘+p2p’ in the Contact header field and SDP (Session Description Protocol) for negotiating MSRP transmission. The content of the SIP INVITE request for MSRP connection setup may be as follows:

INVITE sip:pas@operator.com SIP/2.0
To: <sip:pas@operator.com>
From: <sip:user1@operator.com>;tag=xfg9
Contact: <sip:user1@operator.com>;+p2p
Call-ID: 3413an89KU
Content-Type: application/sdp
Content-Length: 87
c=IN IP4 224.2.17.12/127
m=message 7654 TCP/MSRP *
a=accept-types:text/plain
a=path:msrp://atlanta.operator.com:7654/jshA7weztas;tcp

The P2P AS URI included in the SIP INVITE's request URI may belong to U1's operator's domain. Therefore, the IMS may route the SIP INVITE request to the operator's Serving Call Session Control Function (S-CSCF) 412 in 502. The S-CSCF 412 may check the SIP INVITE's Contact header field and may determine from the included feature tag that the SIP INVITE request is for P2P service. Therefore it may forward the request to the operator's P2P AS PAS 410 in 504.

The P2P AS 410 may accept the offered MSRP media by sending back a corresponding SIP 200 OK response to T1 in 506 and 508.

After having received the SIP 200 OK response, T1 402 may send an MSRP SEND request via the negotiated MSRP connection to the P2P AS in 510. The MSRP SEND request may include a text body specifying a peer list request for the content ID. The MSRP SEND request for requesting a peer list may be as follows:

MSRP a786hjs2 SEND
To-Path: msrp://biloxi.operator.com:12763/kjhd37s2s20w2a;tcp
From-Path: msrp://atlanta.operator.com:7654/jshA7weztas;tcp
Message-ID: 87652491
Byte-Range: 1-65/65
Content-Type: text/plain
P2P-Message-Type: peerlist_request
Content-ID: FootballGame5763
-------a786hjs2$

In 512, the P2P AS PAS 410 may send an MSRP SEND request back to T1 402 including the peer list in its text body. The MSRP SEND request including peer list information may be as follows:

MSRP hs756frm SEND
To-Path: msrp://atlanta.operator.com:7654/jshA7weztas;tcp
From-Path:msrp://biloxi.operator.com:12763/kjhd37s2s20w2a;tcp
Message-ID: 7364559
Byte-Range: 1-187/187
Content-Type: text/plain
P2P-Message-Type: peerlist
Content-ID: FootballGame5763
Peer-List: <sip:user2@operator.com>
<sip:cs@operator.com>;bandwidth=123
-------hs756-frm$

The peer list may include entries of URIs pointing to peers that currently have segments for the wanted video available. In this example, the peer list may include two entries, one for U2's device T2 404 and one for a content server CS 414 in the network (a network peer).

After having received the peer list, end device T1 402 may send SIP INVITE requests to T2 and CS in 514, 516, 518, and 520. The SIP INVITE requests may include a media feature tag ‘+p2p’ in the Contact header field and SDP for negotiating MSRP transmission. The content of the SIP INVITE request for MSRP connection setup for T2 may be as follows:

INVITE sip:user2@operator.com SIP/2.0
To: <sip:user2@operator.com>
From: <sip:user1@operator.com>;tag=xfg9
Contact: <sip:user1@operator.com>;+p2p
Call-ID: 63jgud8576
Content-Type: application/sdp
Content-Length: 87
c=IN IP4 224.2.17.12/127
m=message 7654 TCP/MSRP *
a=accept-types:text/plain
a=path:msrp://atlanta.operator.com:7654/jshA7weztas;tcp

The SIP INVITE requests may be routed via U1's operator's S-CSCF 412. The S-CSCF 412 may route the SIP INVITE requests via the P2P AS PAS 410 to allow it to collect charging related information. The P2P AS 412 finally may route the requests to T2 and CS.

T2 and CS may accept the offered MSRP media by sending back a corresponding SIP 200 OK response to T1 402 in 522, 524, 526 and 528.

After having received the SIP 200 OK responses, T1 402 may send MSRP SEND requests via the negotiated MSRP connections to T2 404 and CS 414 in 530. The MSRP SEND requests may include a text body specifying a bitmap request for the content ID. The MSRP SEND request for requesting a bitmap to T2 may be as follows:

MSRP user774 SEND
To-Path: msrp://biloxi.operator.com:12763/kjhd37s2s20w2a;tcp
From-Path: msrp://atlanta.operator.com:7654/jshA7weztas;tcp
Message-ID: 87345765
Byte-Range: 1-63/63
Content-Type: text/plain
P2P-Message-Type: bitmap_request
Content-ID: FootballGame5763
------- user774$

In 532, T2 404 and CS 414 may send MSRP SEND requests back to T1 402 including their bitmaps in the text bodies. The MSRP SEND request including bitmap information from T2 404 may be as follows:

MSRP gfdze879 SEND
To-Path: msrp://atlanta.operator.com:7654/jshA7weztas;tcp
From-Path: msrp://biloxi.operator.com:12763/kjhd37s2s20w2a;tcp
Message-ID: 738595
Byte-Range: 1-187/187
Content-Type: text/plain
P2P-Message-Type: bitmap
Content-ID: FootballGame5763
Bitmap: 1-22;23-34/90
------- gfdze879$

After having received the bitmaps, T1 402 may check traffic conditions for potential content transmissions from T2 404 and CS 414. T1 402 may have received traffic conditions for CS in the peer list from the P2P AS PAS 410. For traffic conditions for T2 404, T1 402 may check its Bluetooth connection to T2 404 by itself. In this example, it may be assumed that traffic conditions to T2 404 are better than to CS 414. Therefore, in 534, T1 402 may decide to request the first video segment from T2 404.

In 536, 538, 540, and 542. T1 402 may send a SIP re-INVITE request to T2 404 including SDP for the already negotiated MSRP media and additional video media. The IMS may route the request via U1's operator's S-CSCF 412 and P2P AS PAS 410 to T2 404. The PAS 410 may collect charging relevant information from the SIP INVITE dialog and may ensure proper content protection and QoS. The SIP INVITE request for media negotiation may be as follows:

INVITE sip:user2@operator.com SIP/2.0
To: <sip:user2@operator.com>
From: <sip:user1@operator.com>;tag=xfg9
Contact: <sip:user1@operator.com>;+p2p
Call-ID: 63jgud8576
Content-Type: application/sdp
Content-Length: 198
c=IN IP4 224.2.17.12/127
m=message 7654 TCP/MSRP *
a=accept-types:text/plain
a=path:msrp://atlanta.operator.com:7654/jshA7weztas;tcp
m=video 49170/2 RTP/AVP 31

T2 404 may accept the offer in a SIP 200 OK response to T1 402 in 544, 546, 548, and 550. T1 402 may acknowledge the SIP 200 OK response by sending back a SIP ACK response to T2 404.

After having received the SIP ACK response, in 552, T2 404 may start sending the first video segment using the video connection negotiated in the SIP INVITE transaction.

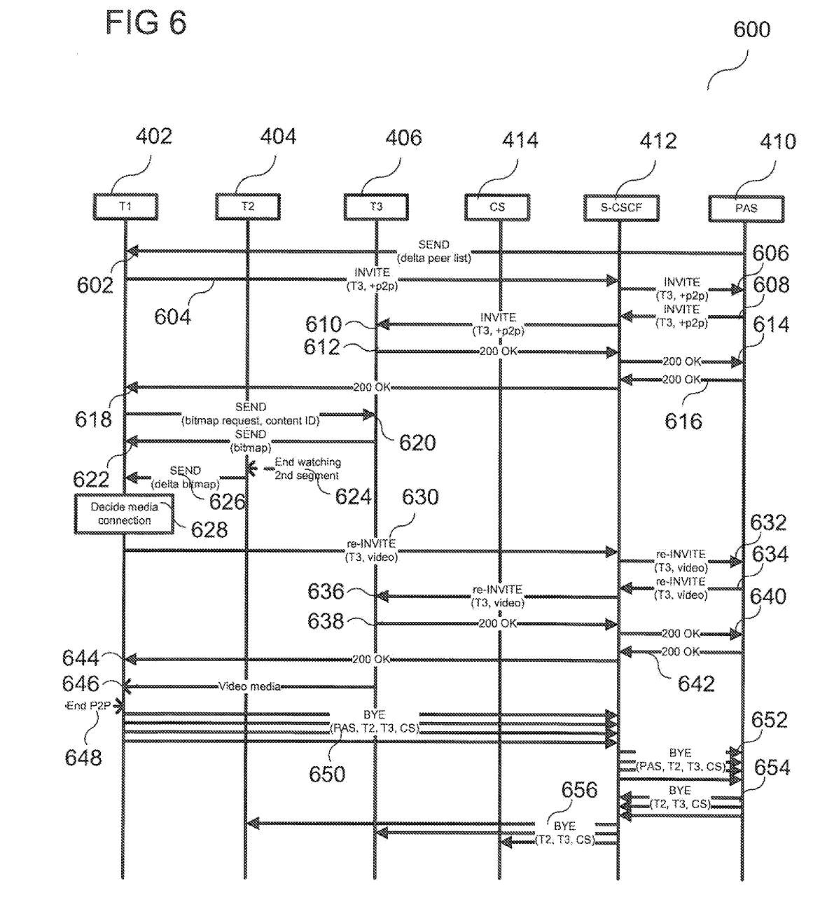

FIG. 6 shows a flow diagram 600 for changing a peer-to-peer communication in the communication system of FIG. 4. A signaling flow for P2P control and termination is shown. For clarity, MSRP 200 OK responses to MSRP SEND requests and SIP ACK responses to SIP 200 OK responses may not be shown in the flow diagram 600.

Later, another user U3's end device T3 406 also downloading the football video may come into Bluetooth reach of T1 402. Therefore, the P2P AS PAS 410 may send another MSRP SEND request to T1 402 in 602. The MSRP SEND request may include delta peer list information in its text body. The MSRP SEND request including delta peer list information may be as follows:

MSRP jhdsf764 SEND
To-Path: msrp://atlanta.operator.com:7654/jshA7weztas;tcp
From-Path: msrp://biloxi.operator.com:12763/kjhd37s2s20w2a;tcp
Message-ID: 439678
Byte-Range: 1-95/95
Content-Type: text/plain
P2P-Message-Type: delta-peerlist
Content-ID: FootballGame5763
Peer-List: <sip:user3@operator.com>
------- jhdsf764$

T1 402 may then, in 604, 606, 608 and 610 send a SIP INVITE request to T3 406 for setting up an MSRP session for P2P control. T3 406 may send a SIP OK response to T1 402 in 612, 614, 616 and 618. After successful session negotiation, T1 402 may in 620 send an MSRP SEND request to T3 406 for requesting bitmap information. In 622, T3 406 may send back an MSRP SEND request including its bitmap information.

During transmission of the first video segment, user U2 may finish watching the second video segment in 624. Therefore, T2 404 may remove the second segment from its memory and may indicate the change to T1 402 by sending another MSRP SEND request to T1 402 including corresponding delta bitmap information in 626.

At the end of watching the first video segment, in 628, T1 402 may decide to request the second video segment from T3 406 based on the received peer list and bitmap information. T1 402 may send a corresponding SIP re-INVITE request to T3 for negotiating the video connection in addition to the existing MSRP connection in 630, 632, 634 and 636. T3 406 may send a SIP OK response to T1 402 in 638, 640, 642 and 644. In 646, video media may be downloaded from T3 406 by T1 402.

After a while, in 648, U1 may decide to stop watching the video. Accordingly T1 may send SIP BYE requests for its SIP INVITE dialogs with PAS 410, T2 404, T3 406 and CS 414 in 650, 652, 654, and 656. The SIP BYE request for terminating a media connection to T3 406 may be as follows:

BYE sip: sip:user3@operator.com SIP/2.0
Max-Forwards: 70
From: <sip:user1@operator.com>;tag=gd7e
To: <sip:user3@operator.com>
Call-ID: hsjf7bfjj
CSeq: 231 BYE
Content-Length: 0

As described above, a peer list may be requested by an MSRP SEND request. A peer list may be provided by an MSRP SEND request. A delta peer list may be provided by an MSRP SEND request. An automatic notification about peer list changes may be provided. A bitmap may be requested by an MSRP SEND request. A bitmap may be provided by an MSRP SEND request. A delta bitmap may be provided by an MSRP SEND request. An automatic notification about bitmap changes may be provided. Peer-to-peer media control messages may be routed via a peer-to-peer application server. MSRP messages may be used for peer-to-peer control. P2P may be provided by IMS operators as an IMS service.

Instead of using the same media feature tag in SIP INVITE requests for setting up MSRP peer list and bitmap control, SEP INVITE requests for setting up MSRP peer list control and SIP INVITE requests for setting up MSRP bitmap control may use different media feature tags.

Peer lists and bitmaps may be transported by multiple MSRP SEND requests each containing only a chunk of the peer list or bitmap. This may allow to transport large peer lists or bitmaps.

Instead of including content-IDs in MSRP text bodies for requesting per lists or bitmaps, the content-ID may be included in MSRP Message-ID header fields.

For MSRP SEND requests, MSRP REPORT requests may be sent back.

Media data may be transported via MSRP. In this case, the existing MSRP connection for bitmap transfer may be also used for media transmission. In this case, media data and bitmap data may be indicated by pre-determined Content-Types and/or Content-Dispositions specified in the MSRP SEND requests Content-Type and Content-Disposition header fields.

The P2P tracker server may be a separate entity from the P2P AS 410.

Instead of including media feature tags in SIP INVITE requests for P2P control, other parameters may be included in SIP INVITE requests to indicate the P2P purpose of the requested SIP session setup.

For tracking the peers' P2P status, the P2P tracker server may subscribe to peer status events by sending SIP SUBSCRIBE requests to peers.

Instead of requesting bitmaps separately from peer lists, bitmaps may be requested together with peer lists from the P2P AS 410 by a single MSRP SEND request. In this case, the P2P AS 410 may collect bitmap information from peers and may provide this information in MSRP SEND requests.

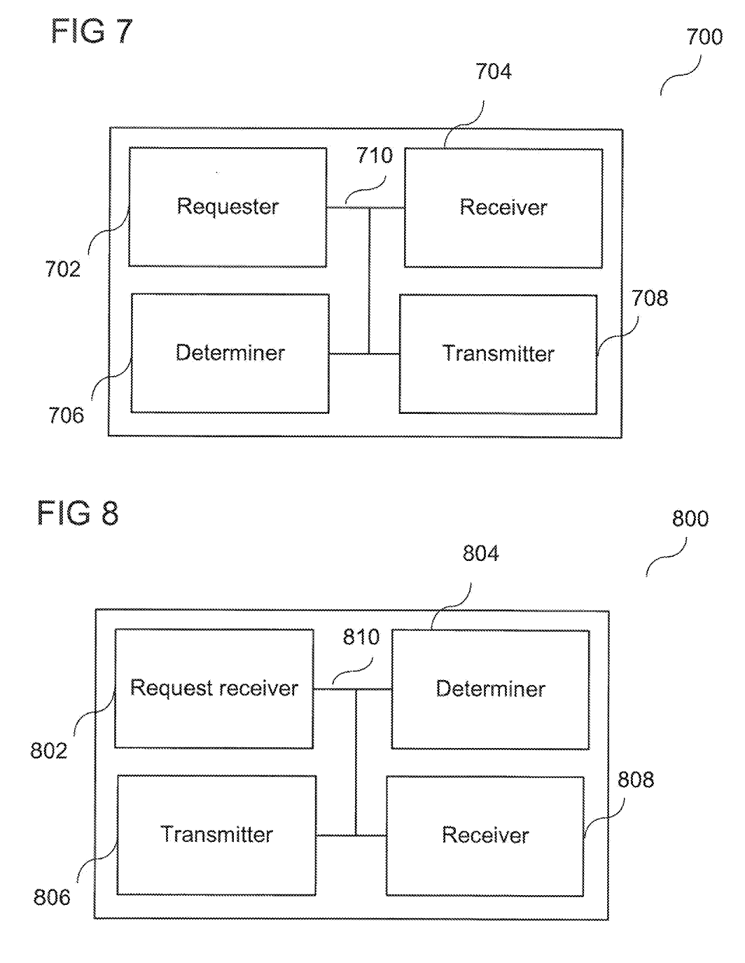

FIG. 7 shows a communication device 700. The communication device 700 may include a requester 702 (or request circuit) to request information indicating communication devices that provide pre-determined data. The communication device 700 may further include a receiver 704 to receive the information indicating communication devices that provide the pre-determined data. The communication device 700 may further include a determiner 706 (or determination circuit) to determine a download target based on the information indicating communication devices that provide the pre-determined data. The communication device 700 may further include a transmitter 708 to transmit information indicating the determined download target for a peer-to-peer communication of the pre-determined data from the download target. The requester, the receiver, the determiner 706, and the transmitter 708 may be coupled with each other, e.g. via a connection 710, for example an optical connection or an electrical connection, such as e.g. a cable or a computer bus or via any other suitable electrical connection to exchange electrical signals.

The information indicating communication devices that provide the pre-determined data may include or may be list information indicating communication devices that provide the pre-determined data.

The requester may request the information indicating communication devices that provide the pre-determined data from a server. The receiver may receive the information indicating communication devices that provide the pre-determined data from the server. The transmitter may transmit the information indicating the determined download target to the server.

The information indicating the determined download target may include or may be information indicating peer-to-peer communication of the pre-determined data from the download target to the communication device 700.

The information indicating peer-to-peer communication may include or may be information requesting the server to initiate peer-to-peer communication of the pre-determined data from the download target to the communication device 700.

The receiver 704 may further receive or be configured to receive information indicating an update in the information indicating communication devices that provide the pre-determined data.

At least one of the requester 702, the receiver 704, and the transmitter 708 may communicate in accordance with a communication session control protocol.

The communication session control protocol may be a Session Initiation Protocol.

At least one of the requester 702, the receiver 704, and the transmitter 708 may communicate in accordance with a communication session protocol.

The communication session protocol may be a Message Session Relay Protocol.

FIG. 8 shows a server 800. The server 800 may include a request receiver 802 to receive from a communication device a request for information indicating communication devices that provide pre-determined data. The server 800 may further include a determiner 804 (or determination circuit) to determine communication devices that provide the pre-determined data. The server 800 may further include a transmitter 806 to transmit to the communication device the requested information indicating communication devices that provide the pre-determined data. The server 800 may further include a receiver 808 to receive from the communication device information indicating a download target for a peer-to-peer communication of the pre-determined data from the download target to the communication device. The receiver 802, the determiner 804, the transmitter 806, and the receiver 808 may be coupled with each other, e.g. via a connection 810, for example an optical connection or an electrical connection, such as e.g. a cable or a computer bus or via any other suitable electrical connection to exchange electrical signals.

The information indicating communication devices that provide the pre-determined data may include or may be list information indicating communication devices that provide the pre-determined data.

The information indicating the download target may include or may be information indicating peer-to-peer communication of the pre-determined data from the download target to the communication device.

The information indicating peer-to-peer communication may include or may be information requesting the server to initiate peer-to-peer communication of the pre-determined data from the download target to the communication device.

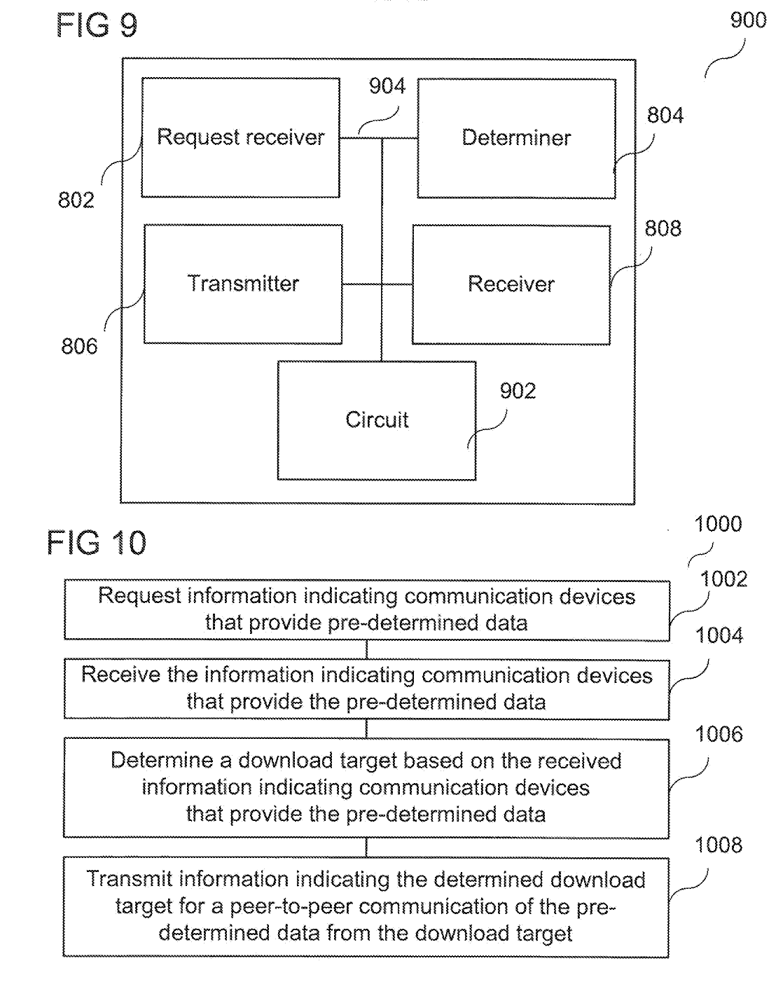

FIG. 9 shows a server 900. The server 900 may, similar to the server 800 of FIG. 8, include a request receiver 802 to receive from a communication device a request for information indicating communication devices that provide pre-determined data. The server 900 may, similar to the server 800 of FIG. 8, further include a determiner 804 to determine communication devices that provide the pre-determined data. The server 900 may, similar to the server 800 of FIG. 8, further include a transmitter 806 to transmit to the communication device the requested information indicating communication devices that provide the pre-determined data. The server 900 may similar to the server 800 of FIG. 8, further include a receiver 808 to receive from the communication device information indicating a download target for a peer-to-peer communication of the pre-determined data from the download target to the communication device. The server 900 may further include a circuit 902, like will be described below. The request receiver 802, the determiner 804, the transmitter 806, the receiver 808, and the circuit 902 may be coupled with each other, e.g. via a connection 904, for example an optical connection or an electrical connection, such as e.g. a cable or a computer bus or via any other suitable electrical connection to exchange electrical signals.

The circuit 902 may initiate a download of the pre-determined data from the download target to the communication device based on the information indicating the download target.

The transmitter 806 may further transmit information indicating an update in the information indicating communication devices that provide the pre-determined data.

At least one of the request receiver 802, the transmitter 806, the receiver 808 and the circuit 902 may be configured to communicate in accordance with a communication session control protocol.

The communication session control protocol may be a Session Initiation Protocol.

At least one of the request receiver 802, the transmitter 806, the receiver 808 and the circuit 902 may communicate in accordance with a communication session protocol.

The communication session protocol may be a Message Session Relay Protocol.

FIG. 10 shows a flow diagram 1000 illustrating a method for controlling a communication device. In 1002, a requester of the communication device may request information indicating communication devices that provide pre-determined data. In 1004, a receiver of the communication device may receive the information indicating communication devices that provide the pre-determined data. In 1006, a determiner of the communication device may determine a download target based on the received information indicating communication devices that provide the predetermined data. In 1008, a transmitter of the communication device may transmit information indicating the determined download target for a peer-to-peer communication of the pre-determined data from the download target.

The information indicating communication devices that provide the pre-determined data may include or may be list information indicating communication devices that provide the pre-determined data.

A requester of the communication device may request the information indicating communication devices that provide the pre-determined data from a server. A receiver of the communication device may receive the information indicating communication devices that provide the pre-determined data from the server. A transmitter of the communication device may transmit the information indicating the determined download target to the server.

The information indicating the determined download target for per-to-peer communication may include or may be information indicating peer-to-peer communication of the pre-determined data from the download target to the communication device.

The information indicating peer-to-peer communication may include or may be information requesting the server to initiate peer-to-peer communication of the pre-determined data from the download target to the communication device.

The method may further include receiving information indicating an update in the information indicating communication devices that provide the pre-determined data.

At least one of the requesting 1002, the received information (1004), the transmitted information (1008) and the received information indicating an update may be in accordance with a communication session control protocol.

The communication session control protocol may be a Session Initiation Protocol.

At least one of the requesting 1002, the received information (1004), the transmitted information (1008) and the received information indicating an update may be in accordance with a communication session protocol.

The communication session protocol may be a Message Session Relay Protocol.

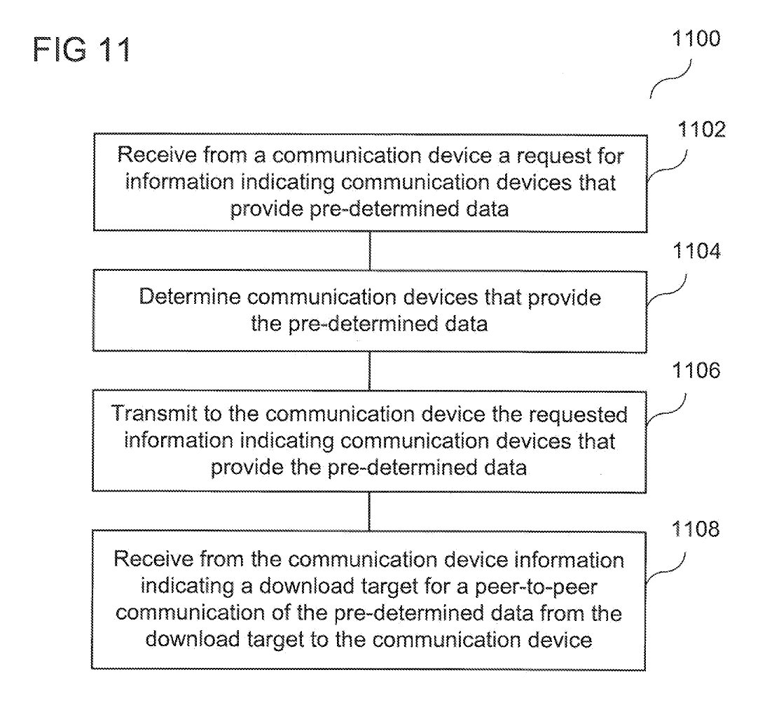

FIG. 11 shows a flow diagram 1100 illustrating a method for controlling a server. In 1102, a request receiver of the server may receive from a communication device a request for information indicating communication devices that provide pre-determined data. In 1104, a determiner of the server may determine communication devices that provide the pre-determined data. In 1106, a transmitter of the server may transmit to the communication device the requested information indicating communication devices that provide the pre-determined data. In 1108, a receiver of the server may receive from the communication device information indicating a download target for a peer-to-peer communication of the pre-determined data from the download target to the communication device.

The information indicating communication devices that provide the pre-determined data may include or may be list information indicating communication devices that provide the pre-determined data.

The information indicating the download target may include or may be information indicating peer-to-peer communication of the pre-determined data from the download target to the communication device.

The information indicating peer-to-peer communication may include or may be information requesting the server to initiate peer-to-peer communication of the pre-determined data from the download target to the communication device.

The method may further include initiating a download of the pre-determined data from the download target to the communication device based on the information indicating the download target.

The method may further include transmitting information indicating an update in the information indicating communication devices that provide the pre-determined data.

At least one of the received information (1102), the transmitted information (1106), the received information (1108), the initiating, and the transmitted information indicating an update may be in accordance with a communication session control protocol.

The communication session control protocol may be a Session Initiation Protocol.

At least one of the received information (1102), the transmitted information (1106), the received information (1108), the initiating, and the transmitted information indicating an update may be in accordance with a communication session protocol.

The communication session protocol may be a Message Session Relay Protocol.

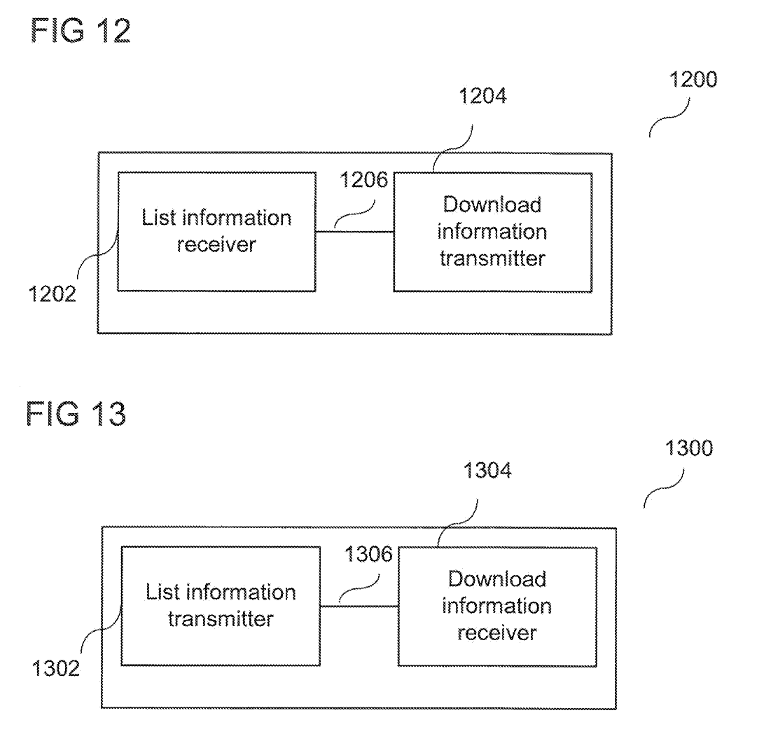

FIG. 12 shows a communication device 1200. The communication device 1200 may include a list information receiver 1202 configured to receive from a server list information indicating communication devices which provide pre-determined data. The communication device 1200 may further include a download information transmitter 1204 configured to transmit to the server information indicating at least one of the communication devices indicated in the list information as a download target for peer-to-peer communication of pre-determined data from the download target to the communication device. The list information receiver 1202 and the download information transmitter 1204 may be coupled with each other, e.g. via a connection 1206, for example an optical connection or an electrical connection, such as e.g. a cable or a computer bus or via any other suitable electrical connection to exchange electrical signals.

FIG. 13 shows a server 1300. The server 1300 may include a list information transmitter 1302 configured to transmit to a communication device list information indicating communication devices which provide pre-determined data. The server 1308 may further include a download information receiver 1304 configured to receive from the communication device information indicating at least one of the communication devices indicated in the list information as a download target for peer-to-peer communication of pre-determined data from the download target to the communication device. The list information transmitter 1302 and the download information, receiver 1304 may be coupled with each other, e.g. via a connection 1306, for example an optical connection or an electrical connection, such as e.g. a cable or a computer bus or via any other suitable electrical connection to exchange electrical signals.

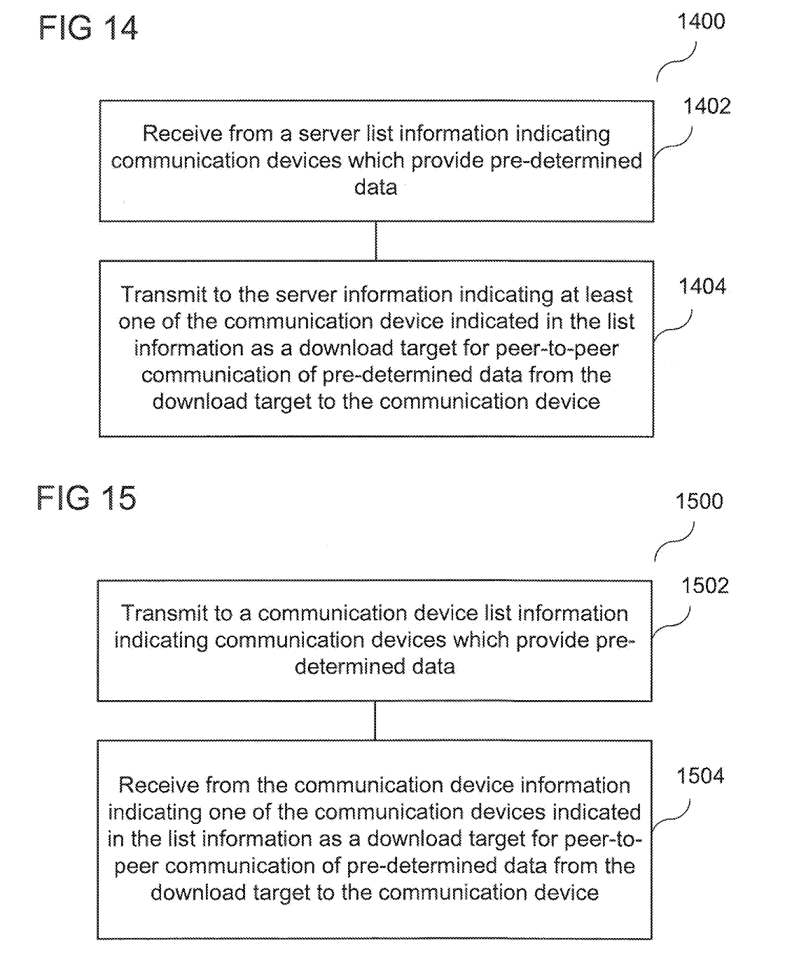

FIG. 14 shows a flow diagram 1400 illustrating a method for controlling a communication device. In 1402, a list information receiver of the communication device may receive from a server list information indicating communication devices which provide pre-determined data in 1404, a download information transmitter of the communication device may transmit to the server information indicating at least one of the communication devices indicated in the list information as a download target for peer-to-peer communication of pre-determined data from the download target to the communication device.

FIG. 15 shows a flow diagram 1500 illustrating a method for controlling a server. In 1502, a list information transmitter of the server may transmit to a communication device list information indicating communication devices which provide pre-determined data. In 1504, a download information receiver of the server may receive from the communication device information indicating at least one of the communication devices indicated in the list information as a download target for peer-to-peer communication of predetermined data from the download target to the communication device.

Any one of the communication devices described above may be configured according to at least one of the following radio access technologies: a Bluetooth radio communication technology, an Ultra Wide Band (UWB) radio communication technology, and/or a Wireless Local Area Network radio communication technology (for example according to an IEEE 802.11 (for example IEEE 802.11n) radio communication standard)), IrDA (Infrared Data Association), Z-Wave and ZigBee, HiperLAN/2 ((High PErformance Radio LAN; an alternative ATM-like 5 GHz standardized technology). IEEE 802.11a (5 (1 Hz), IEEE 802.11g (2.4 GHz), IEEE 802.11n, IEEE 802.11VHT (VHT=Very High Throughput), Worldwide Interoperability for Microwave Access (WiMax) (for example according to an IEEE 802.16 radio communication standard, for example WiMax fixed or WiMax mobile), WiPro, HiperMAN (High Performance Radio Metropolitan Area Network) and/or IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (for example UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 30 (Third Generation), CSD (Circuit Switched Data), HSCSD (High-Speed Circuit-Switched Data), UMTS (30) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (20), CDMA2000 (3G) (Code division multiple access 2000 (Third generation)), EV-DO (Evolution-Data Optimized or Evolution-Data Only), AMPS (10) (Advanced Mobile Phone System (1st Generation)), TACS/ETACS (Total Access Communication System/Extended Total Access Communication System), 1)-AMPS (2G) (Digital AMPS (2nd Generation)), PTT (Push-to-talk), MTS (Mobile Telephone System), IMTS (improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data) PHS (Personal Handy-phone System), WiDEN (Wideband Integrated Digital Enhanced Network), iBurst, Unlicensed Mobile Access (UMA, also referred to as also referred to as 3GPP Generic Access Network, or CAN standard).

While the invention has been particularly shown and described with reference to specific aspects of this disclosure, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A communication device comprising:
a requester to request information indicating communication devices that provide pre-determined data;
a receiver to receive the information indicating communication devices that provide the pre-determined data;
a determiner to determine a download target based on the information indicating communication devices that provide the pre-determined data; and
a transmitter to transmit information indicating the determined download target for a peer-to-peer communication of the pre-determined data from the download target.

2. The communication device of claim 1,
wherein the information indicating communication devices that provide the pre-determined data comprises list information indicating communication devices that provide the pre-determined data.

3. The communication device of claim 1,
wherein the requester requests the information indicating communication devices that provide the pre-determined data from a server;
wherein the receiver receives the information indicating communication devices that provide the pre-determined data from the server; and
wherein the transmitter transmits the information indicating the determined download target to the server.

4. The communication device of claim 1,
wherein the information indicating the determined download target comprises information indicating the peer-to-peer communication of the pre-determined data from the download target to the communication device.

5. The communication device of claim 1,
wherein the receiver further receives information indicating an update in the information indicating communication devices that provide the pre-determined data.

6. The communication device of claim 1,
wherein at least one of the requester, the receiver, and the transmitter communicates in accordance with a communication session control protocol.

7. The communication device of claim 6,
wherein the communication session control protocol is a Session Initiation Protocol.

8. The communication device of claim 1,
wherein at least one of the requester, the receiver, and the transmitter communicates in accordance with a communication session protocol.

9. (canceled)

10. A server comprising:
a request receiver to receive from a communication device a request for information indicating communication devices that provide pre-determined data;
a determiner to determine communication devices that provide the pre-determined data;
a transmitter to transmit to the communication device the requested information indicating communication devices that provide the pre-determined data; and
a receiver to receive from the communication device information indicating a download target for a peer-to-peer communication of the pre-determined data from the download target to the communication device.

11. The server of claim 10,
wherein the information indicating communication devices that provide the pre-determined data comprises list information indicating communication devices that provide the pre-determined data.

12. The server of claim 10,
wherein the information indicating the download target comprises information indicating the peer-to-peer communication of the pre-determined data from the download target to the communication device.

13. The server of claim 10, further comprising:
a circuit to initiate a download of the pre-determined data from the download target to the communication device based on the information indicating the download target.

14. The server of claim 10,
wherein the transmitter further transmits information indicating an update in the information indicating communication devices that provide the pre-determined data.

15. The server of claim 10,
wherein at least one of the request receiver, the transmitter, and the receiver communicates in accordance with a communication session control protocol.

16. (canceled)

17. The server of claim 10,
wherein at least one of the request receiver, the transmitter, and the receiver communicates in accordance with a communication session protocol.

18. (canceled)

19. A method for controlling a communication device, the method comprising:
requesting information indicating communication devices that provide pre-determined data;
receiving the information indicating communication devices that provide the pre-determined data;
determining a download target based on the received information indicating communication devices that provide the predetermined data; and
transmitting information indicating the determined download target for a peer-to-peer communication of the pre-determined data from the download target.

20. The method of claim 19,
wherein the information indicating communication devices that provide the pre-determined data comprises list information indicating communication devices that provide the pre-determined data.

21. The method of claim 19,
wherein a requester of the communication device requests the information indicating communication devices that provide the pre-determined data from a server;
wherein a receiver of the communication device receives the information indicating communication devices that provide the pre-determined data from the server; and
wherein a transmitter of the communication device transmits the information indicating the determined download target to the server.

22. The method of claim 21,
wherein the information indicating the determined download target comprises information indicating the peer-to-peer communication of the pre-determined data from the download target to the communication device.

23. The method of claim 19, further comprising:
receiving information indicating an update in the information indicating communication devices that provide the pre-determined data.

24. The method of claim 19,
wherein at least one of the requesting, the received information, and the transmitted information is in accordance with a communication session control protocol.

25. (canceled)

26. A method for controlling a server, the method comprising:
receiving from a communication device a request for information indicating communication devices that provide pre-determined data;
determining communication devices that provide the pre-determined data;
transmitting to the communication device the requested information indicating communication devices that provide the pre-determined data; and
receiving from the communication device information indicating a download target for a peer-to-peer communication of the pre-determined data from the download target to the communication device.

27. The method of claim 26,
wherein the information indicating communication devices that provide the pre-determined data comprises list information indicating communication devices that provide the pre-determined data.

28. The method of claim 26,
wherein the information indicating the download target comprises information indicating peer-to-peer communication of the pre-determined data from the download target to the communication device.

29. The method of claim 26, further comprising:
initiating a download of the pre-determined data from the download target to the communication device based on the information indicating the download target.

30. The method of claim 26,
wherein at least one of the requesting, the transmitted information, and the received information is in accordance with a communication session control protocol.

31. (canceled)
